(19) United States
(12) Patent Application Publication
(10) Pub. No.: US 2007/0148479 A1
(43) Pub. Date: Jun. 28, 2007

(54) Corrosion-protection by electrochemical deposition of metal oxide layers on metal substrates

(76) Inventors: Hiroki Ishikazi, Osaka (JP); Matthias Schweinsberg, Langenfeld (DE); Seishiro Ito, Nara (JP); Frank Wiechmann, Duesseldorf (DE)

Correspondence Address: HENKEL CORPORATION, THE TRIAD, SUITE 200, 2200 RENAISSANCE BLVD., GULPH MILLS, PA, 19406, US

(21) Appl. No.: 11/471,330

(22) Filed: Jun. 20, 2006

Related U.S. Application Data
(63) Continuation of application No. PCT/EP04/14140, filed on Dec. 11, 2004.

(30) Foreign Application Priority Data
Dec. 22, 2003 (EP) 03029544.8

(51) Int. Cl. B32B 15/04; C25D 11/00

(52) U.S. Cl. 428/469; 428/472; 205/333

(57) ABSTRACT

The present invention relates to a process for providing a metal substrate with corrosion-protection and corrosion-resistance, respectively, as well as to the products thus obtainable. Said process comprises coating said metal substrate with a thin layer of at least one metal oxide selected from the group consisting of TiO₂, Bi₂O₃ and ZnO, preferably TiO₂, by electrochemically depositing said metal oxide layer on at least one surface of said metal substrate. At the same time, said metal oxide layer may serve as a primer layer for subsequent coating treatment (e.g. coating with organic materials, such as for instance lacquers, varnishes, paints, organic polymers, adhesives, etc.).

### CROSS-REFERENCE TO RELATED APPLICATIONS

This application is a continuation under 35 USC Sections 365(c) and 120 of International Application Number PCT/EP2004/014140, having an international filing date of Dec. 11, 2004, published in English on Jul. 14, 2005 as International Publication Number WO2005/064045A1, and claiming priority to European Application Number EP 03029544.8 filed on Dec. 22, 2003, both of which are incorporated herein by reference in their entirety.

### FIELD OF THE INVENTION

The present invention relates to a process of providing a conductive metal substrate with corrosion-protection or corrosion-resistance, respectively, by electrochemically depositing a metal oxide layer on said metal substrate. At the same time, such metal oxide layer deposited electrochemically may serve as an appropriate primer layer for subsequent coating treatment (e.g. coating with organic materials, such as for instance lacquers, varnishes, paints, organic polymers, adhesives, etc.).

Further, according to a second aspect of the invention, the present invention relates to a conductive metal substrate obtained according to the aforementioned process, said metal substrate being provided with an (enhanced) corrosion-protection/corrosion-resistance via an electrochemical metal oxide deposit coated/applied on at least one surface of said metal substrate.

Finally, according to a third aspect of the invention, the present invention refers to the use of metal oxide layers deposited electrochemically on conductive metal substrates for providing said metal substrates with an enhanced anticorrosive or corrosion-resistant properties, said metal oxide layers serving, at the same time, as a primer for subsequent coating treatment as described above.

### BACKGROUND OF THE INVENTION

A very common industrial task involves providing metallic or non-metallic substrates with a first coating, which has a corrosion-inhibiting effect and/or which constitutes a primer for the application thereon of a subsequent coating containing e.g. organic polymers. An example of such a task is the pre-treatment of metals prior to lacquer coating, for which various processes are available in the art. Examples of such processes are layer-forming or non-layer-forming phosphating, chromating or a chromium-free conversion treatment, for example using complex fluorides of titanium, zirconium, boron or silicon. Technically simpler to perform, but less effective, is the simple application of a primer coat to a metal prior to lacquer-coating thereof. An example of this is the application of red lead. Alternatives to so-called “wet” processes are so-called “dry” processes, in which a corrosion-protection or coupling layer is applied by gas phase deposition. Such processes are known, for example, as PVD or CVD processes. They may be assisted electrically, for example by plasma discharge.

A layer produced or applied in this way may serve as a corrosion-protective primer for subsequent lacquer coating. However, the layer may also constitute a primer for subsequent bonding. Metallic substrates in particular, but also substrates of plastics or glass, are frequently pre-treated chemically or mechanically prior to bonding in order to improve adhesion of the adhesive to the substrate. For example, in vehicle or equipment construction, metal or plastics components may be bonded metal-to-metal, plastics to plastics or metal to plastics. At present, front and rear windscreens of vehicles are as a rule bonded directly into the bodywork. Other examples of the use of coupling layers are to be found in the production of rubber/metal composites, in which once again the metal substrate is as a rule pre-treated mechanically or chemically before a coupling layer is applied for the purpose of bonding with rubber.

The conventional wet or dry coating processes in each case exhibit particular disadvantages. For example, chromating processes are disadvantageous from both an environmental and an economic point of view owing to the toxic properties of the chromium and the occurrence of highly toxic sludge. However, chromium-free wet processes, such as phosphating, as a rule, also result in the production of sludge containing heavy metals, which has to be disposed of at some expense. Another disadvantage of conventional wet coating processes is that the actual coating stage frequently has to be preceded or followed by further stages, thereby increasing the amount of space required for the treatment line and the consumption of chemicals. For example, phosphating, which is used virtually exclusively in automobile construction, entails several cleaning stages, an activation stage and generally a post-passivation stage. In all these stages, chemicals are consumed and waste is produced which has to be disposed of.

Although dry coating processes entail fewer waste problems, they have the disadvantage of being technically complex to perform (for example requiring a vacuum) or of having high-energy requirements. The high operating costs of these processes are therefore a consequence principally of plant costs and energy consumption.

Further, it is known from the prior art that thin layers of metal compounds, for example oxide layers, may be produced electrochemically on an electrically conductive substrate. For example, the article by Y. Zhou and J. A. Switzer entitled “Electrochemical Deposition and Microstructure of Copper (I) Oxide Films”, Scripta Materialia, Vol. 38, No. 11, pages 1731 to 1738 (1998), describes the electrochemical deposition and microstructure of copper (I) oxide films on stainless steel. The article investigates above all the influence of deposition conditions on the morphology of the oxide layers; it does not disclose any practical application of the layers.

The article by M. Yoshimura, W. Suchanek, K-S. Han entitled “Recent developments in soft solution processing: One step fabrication of functional double oxide films by hydrothermal-electrochemical methods”, J. Mater. Chem., Vol. 9, pages 77 to 82 (1999), investigates the production of thin films of double oxides by a combination of hydrothermal and electrochemical methods. The production of ceramic materials is given as an example of application. The article does not contain any indication as to the usability of such layers for corrosion protection or as a primer.

Electrochemical formation of an oxide layer also occurs in the processes known as anodic oxidation. However, in these processes the metal originates from the metal substrate itself so that part of the metal substrate is destroyed during oxide layer formation.

It is also known to assist the formation of crystalline zinc phosphate layers electrochemically. However, the disadvantages of phosphating (necessity of several sub-stages, such as activation, phosphating, post-passivation, as well as the occurrence of phosphating sludge) are not overcome thereby.

Matsumoto et al. in J. Phys. Chem. B, 104, 4204 (2000) (Abstract) report that TiO₂-layers are grown on an Al₂O₃/Al-sheet or Ti-sheet from an aqueous solution by a two-step electrodeposition. First-step electrolysis (anodization) exhibits that an Al₂O₃-layer is obtained on an Al-sheet from H₂SO₄ aqueous solution. Second-step electrolysis (combination of cathodic and anodic electrolysis) exhibits that TiO₂-layer is grown on Al₂O₃/Al-sheet from (NH₄)₂[TiO(C₂O₄)] aqueous solution at pH-values below 4. The resulting amorphous TiO₂-layers have to be sintered to obtain crystalline TiO₂-layers with photocatalytic activity. However, TiO₂-layers as grown by the two-step electrodeposition without subsequent sintering have amorphous structure, as reported by the authors.

According to Blandeu et al. in Thin Solid Film, 42, 147 (1997) (Abstract), TiO₂-layers are obtained on a Ti-sheet from H₂SO₄ aqueous solution by anodic oxidation method. This is obtained at potentials below 50 V. However, this process can produce TiO₂ only on Ti-substrates by anodic oxidation.

According to Nogami et al. in J. Electrochem. Soc., 135, 3008 (1988) (Abstract), TiO₂ is obtained on a Ti-sheet from an aqueous solution containing 0.5 mol/L H₂SO₄ and 0.03 mol/L HNO₃ by anodic oxidation method (titanium anodization). Constant current is 1 mA/cm². The oxidation is performed in a cooled bath of 278 K to 283 K. However, this process can produce TiO₂ only on a Ti-substrate by anodic oxidation.

In U.S. Pat. No. 4,882,014 ceramic precursor compositions, such as metal hydroxides and oxides, are electrochemically deposited in a biased electrochemical cell. The cell typically generates hydroxide ions that precipitate metallic or semi-metallic ions to form insoluble solids that may be separated from the cell, then dried, calcined and sintered to form a ceramic composition. However, this electrochemical deposition produces these layers in amorphous structure only.

In JP 11-158691 TiO₂-layers are electrochemically formed on conductive substrates from a titanium-ion aqueous solution, further containing nitrate ions, complex agents and peroxides at pH-values above 3. Referring to the X-ray photoelectron spectrum of this layer, all peak lines were corresponding to that of Ti and O in TiO₂. However, this process requires the presence of peroxide, which causes the instability of the electrolyte solution.

Recently, titanium dioxide layers were obtained by several physical deposition techniques and several chemical deposition techniques. However, these methods have several problems mentioned in the following:

The problems related to prior art physical deposition techniques (e.g. radio frequency magnetron sputtering, metal organic chemical vapor deposition and molecular beam epitaxy) are shown by the following: Since titanium dioxide layers with crystal structure are obtained at high substrate temperature, these layers cannot be obtained on material with melting point below 373 K. Further, such physical deposition techniques are very cost-intensive and difficult to manage so that such physical deposition techniques are inappropriate for industrial application.

The problems related to prior art chemical deposition techniques (e.g. sol-gel method, chemical bath deposition and chemical liquid deposition) are shown by the following: TiO precursor-layers are obtained by these deposition techniques and then TiO layers crystallize as anatase or rutile structures by using heat-treatment. Thus, these layers cannot be obtained on material with a melting point below 373 K.

The problems related to prior art electrolysis techniques are particularly shown by the following: TiO precursor-layers are obtained from electrolytes containing HF, NH₃, peroxides and Ti ions etc. at pH-values below 4 by electrochemical deposition; due to the use of acidic HF-solutions, such electrolyte is environmentally non-friendly. The existence of peroxide and nitrate ions exhibits the decrease in the stability of such electrolyte. Since a TiO precursor-layer crystallizes as anatase or rutile structures only by using subsequent heat-treatment, these layers cannot be obtained on material with a melting point below 373 K.

Thus, there do not exist any publications that report on the preparation of a TiO₂-layer with crystalline structure by one-step electrodeposition, especially not from a peroxide-free electrolyte.

For this reason, there is a need for a process that provides a metal substrate with corrosion-protection and/or corrosion-resistance, respectively, said process avoiding or at least minimizing the disadvantages of the prior art processes discussed before.

In particular, there is a need for a new coating process for producing corrosion-protection and/or primer layers, which require less expenditure on apparatus than dry processes and are associated with lower chemical consumption and a smaller volume of waste than wet processes.

### SUMMARY OF THE INVENTION

Applicant has now surprisingly found that the problems related to the prior art processes can be overcome by coating a metal substrate to be provided with corrosion-protection and/or corrosion-resistance with a thin layer of at least one metal oxide selected from the group consisting of TiO₂, Bi₂O₃ and ZnO by electrochemically depositing the metal oxide layer on the metal substrate.

An object of the invention is a process for providing a metal substrate with corrosion-protection and/or corrosion-resistance, the process comprising: coating the metal substrate with a thin layer of at least one metal oxide selected from the group consisting of TiO₂, Bi₂O₃ and ZnO, preferably TiO₂, by electrochemically depositing the metal oxide layer on at least one surface of the metal substrate. Desirably, the metal oxide layer is obtained as an abrasion-resistant and dense, compact layer on at least one surface of the metal substrate and/or wherein the metal oxide layer is deposited with an essentially homogeneous and continuous thickness and/or wherein the metal oxide layer is deposited as an essentially continuous coating being essentially free of cracks.

In a preferred embodiment, the metal oxide layer is a TiO₂-layer. In a particularly preferred embodiment, the TiO₂-layer is deposited on the metal substrate with an essentially uniform layer thickness, the maximum layer thickness, calculated as weight per unit area, being up to 3.5 g/m2, especially less than up to 3.0 g/m2, preferably less than up to 1.5 g/m2, more preferably less than up to 1.0 g/m2; and/or the minimum layer thickness, calculated as weight per unit area, being at least 0.01 g/m2, preferably at least 0.05 g/m2, more preferably at least 0.1 g/m2; and/or the TiO₂-layer is deposited on the metal substrate with an essentially uniform layer thickness, calculated as weight per unit area, in the range of from 0.01 to 3.5 g/m², preferably in the range of from 0.5 to 1.4 g/m².

It is another object of the invention to provide a process according to the invention, wherein the metal oxide layer is a ZnO-layer, especially wherein the ZnO-layer is deposited on the metal substrate with an essentially uniform layer thickness, calculated as weight per unit area, in the range of from 0.01 to 9.0 g/m2, preferably in the range of from 1.4 to 8.5 g/m2, more preferably in the range of from 1.5 to 4 g/m2; or

wherein the metal oxide layer is a Bi₂O₃-layer, especially wherein the Bi₂O₃-layer is deposited on the metal substrate with an essentially uniform layer thickness, calculated as weight per unit area, in the range of from 0.01 to 8.0 g/m2, preferably in the range of from 0.5 to 6.0 g/m2, more preferably in the range of from 0.9 to 5.1 g/m2

It is another object of the invention to provide a process according to the invention wherein electrochemical deposition is performed in an electrolytic bath containing:
(i) at least one appropriate precursor salt of the metal oxide, the precursor salt being soluble in the electrolytic bath and being electrochemically deposable as a metal oxide;
(ii) at least one conducting salt; and
(iii) optionally one or more additives and/or aids, especially selected from the group consisting of: stabilizers; complexing or sequestering agents, such as chelating agents (chelators); accelerators or promoting agents; buffering agents.

In a one embodiment the electrochemical deposition is run galvanostatically and/or wherein the electrochemical deposition is performed at a temperature in the range of between 0 and 100° C., especially 20 and 60° C., and/or with a current density, especially a cathodic current density, of between 0.01 and 100 mA/cm2, especially 0.1 and 10 mA/cm2, and/or for a duration of between 30 seconds and 20 minutes, especially 30 seconds and 10 minutes, preferably 1 and 5 minutes.

In another embodiment, the electrochemical deposition is performed in an essentially peroxide-free electrolyte and/or wherein the electrochemical deposition is performed in an electrolyte being essentially free of halides, especially chlorides and fluorides.

In another aspect, an object of the invention is a metal substrate provided with a corrosion-protection and/or corrosion-resistance, wherein the metal substrate is coated on at least one surface with an abrasion-resistant and dense, compact layer of at least one metal oxide selected from the group consisting of TiO₂, Bi₂O₃ and ZnO, preferably TiO₂, the metal oxide layer being electrochemically deposited on the metal substrate.

In a preferred embodiment, the metal oxide layer is a TiO₂-layer deposited on the metal substrate with an essentially uniform thickness, especially with a layer thickness, calculated as weight per unit area, in the range of from 0.01 to 3.5 g/m2, preferably in the range of from 0.5 to 1.4 g/m2; and/or wherein the metal substrate is a conductive metal substrate, especially selected from the group consisting of iron, aluminum, magnesium and their alloys and mixtures, especially steel of all kinds, such as galvanized steel and cold-rolled steel.

In another aspect, an object of the invention is the use of a metal oxide layer coated on a conductive metal substrate as an anticorrosive and/or corrosion-resistant layer and/or as a primer for subsequent coating, wherein the metal oxide layer is electrochemically deposited on at least one surface of the metal substrate as an abrasion-resistant and dense, compact coating layer, wherein the metal oxide of the metal oxide layer is selected from the group consisting of TiO₂, Bi₂O₃ and/or ZnO, preferably TiO₂.

### BRIEF DESCRIPTION OF THE DRAWINGS

FIG. 1-1 shows the X-ray diffraction spectra for the TiO₂-layers of Example 1-1 obtained at cathodic potential of −1.2 V, −1.0 V and −0.8 V.

FIG. 1-2 shows the X-ray diffraction spectra of the TiO₂-layers of Example 1-2 obtained at cathodic current density of −4 mA/cm² and −5 mA/cm².

FIG. 2-1 shows scanning electron micrographs of the surface morphology for the TiO₂-layers of Example 2 formed at varied cathodic potentials: FIG. 2-1(a): cathodic potential of −1.3 V; FIG. 2-1(b): cathodic potential of −1.2 V; FIG. 2-1(c): cathodic potential of −1.0 V.

FIG. 2-2 shows the X-ray diffraction spectra for the TiO₂-layers of Example 2 obtained at cathodic potentials of −1.3 V, −1.2 V and −1.0 V.

FIG. 2-2-1 shows a comparison of the X-ray diffraction spectra of (a) the TiO₂-layers of Example 2 obtained at cathodic potential of −1.3 V; (b) pure crystalline rutile; and (c) pure crystalline anatase.

FIG. 2-3 shows the X-ray photoelectron spectra of the TiO₂-layers of Example 2 formed at varied cathodic potentials: the middle curve corresponds to a cathodic potential of −1.3 V; the lower curve corresponds to a cathodic potential of −1.2 V; and the upper curve corresponds to a cathodic potential of −1.0 V.

FIG. 2-4 shows the Ti₂ₚ electron spectrum (FIG. 2-4(a)) and the O₁ₛ electron spectrum (FIG. 2-4(b)) for the TiO₂-layer of Example 2 electrochemically deposited at cathodic potential of −1.3 V.

FIG. 3-1 shows scanning electron micrographs of the cross-section morphology for the TiO₂-layers of Example 3 formed at varied cathodic potentials: FIG. 3-1(a): cathodic potential of −1.3 V; FIG. 3-1(b): cathodic potential of −1.2 V; FIG. 3-1(c): cathodic potential of −1.0 V.

FIG. 3-2 shows the X-ray diffraction spectra for the TiO₂-layers of Example 3 obtained at cathodic potentials of −1.3 V, −1.2 V and −1.0 V.

FIG. 4-1 shows scanning electron micrographs of the surface morphology for the TiO₂-layers of Example 4-1 formed, without stirring, at varied cathodic potentials: FIG. 4-1(a): cathodic potential of −1.4 V; FIG. 4-1(b): cathodic potential of −1.2 V; FIG. 4-1(c): cathodic potential of −1.0 V.

FIG. 4-2 shows the X-ray photoelectron spectra of the TiO₂-layers of Example 4-1 electrochemically obtained, without stirring, at a cathodic potential of −1.0 V.

FIG. 4-3 shows the surface morphology for the TiO₂-layers of Example 4-2 electrochemically grown, with stirring, at cathodic potential of −1.0 V.

FIG. 4-4 shows the X-ray photoelectron spectra of the TiO₂-layer of Example 4-2 electrochemically obtained, with stirring, at cathodic potential of −1.0 V.

FIG. 5 shows the results of corrosion tests on steel plates coated according to the invention. The creepage in mm was given at the y-axis (ordinate), whereas the x-axis (abscissa) shows the thickness of the respective metal oxide layer electrochemically deposited on the respective metal substrate. Any coating-layer thickness-value given at the bottom of said x-axis in FIG. 5 refers directly to the respective bar above such value.

### DETAILED DESCRIPTION OF PREFERRED EMBODIMENTS

According to a first aspect of the present invention, the present invention relates to a process for providing a metal substrate with corrosion-protection and/or corrosion-resistance, said process comprising coating said metal substrate with a thin layer of at least one metal oxide selected from the group consisting of TiO₂, Bi₂O₃ and ZnO by electrochemically depositing said metal oxide layer on at least one surface of said metal substrate.

As a metal substrate, all kinds of conductive metal substrates may generally be used in the process in the present invention, provided that they are compatible with said process. Preferably, the metal substrate should be conductive in order to be used in the process according to the present invention. Especially preferred are metal substrates selected from the group consisting of iron, aluminum, magnesium as well as their respective alloys and mixtures. Typical examples are aluminum and preferably steels of all kinds, such as e.g. galvanized steels (e.g. electrolytically galvanized steels and hot-dip galvanized steels) as well as cold-rolled steels. Applicant has surprisingly found that the process of the present invention—in contrast to prior art deposition techniques—is even applicable with respect to technical steels.

According to the process of the present invention, the metal oxide layer is obtained as an abrasion-resistant and dense, compact layer on at least one surface of said metal substrate. Preferably, said metal oxide layer is deposited with an essentially homogeneous and continuous thickness, i.e. said metal oxide layer is deposited as an essentially continuous coating being essentially free of cracks. However, “continuous coating” also comprises embodiments where the metal oxide layer is formed by single crystallites that are closely/tightly packed to one another (e.g. in the case of ZnO— and Bi₂O₃-layers), such that the surface of the metal substrate is at least essentially covered with said metal oxide layer. Generally, more than 90%, desirably more than 95%, preferably more than 99%, of the surface of said metal substrate to be coated is covered by the electrochemical deposit of TiO₂, ZnO or Bi₂O₃, respectively, all values referring to the net area of said surface to be coated. Advantageously, both macroscopically and microscopically, essentially no “free”, uncoated sites are to be discovered on the metal surface coated according to the process of the present invention.

If a ZnO-layer is used as the metal oxide layer, said ZnO-layer is deposited on said metal substrate with an essentially uniform layer thickness, calculated as weight per unit area, in the range of from 0.01 to 9.0 g/m², preferably in the range of from 1.4 to 8.5 g/m², more preferably in the range of from 1.5 to 4 g/m². The lower limits are due to the fact that a certain minimum thickness is needed for providing the metal substrate with sufficient corrosion-protection and corrosion-resistance at all, whereas the upper limits are due to the fact that above a certain thickness, no enhancements of the corrosion-protection or corrosion-resistance can be reached; but nevertheless, it might be possible to deviate from the afore-mentioned limits if this is required according to applicational necessities.

If a Bi₂O₃-layer is used as the metal oxide layer, said Bi₂O₃-layer is deposited on said metal substrate with an essentially uniform layer thickness, calculated as weight per unit area, in the range of from 0.01 to 8.0 g/m², preferably in the range of from 0.5 to 6.0 g/m², more preferably in the range of from 0.9 to 5.1 g/m². The lower limits are due to the fact that a certain minimum thickness is needed for providing the metal substrate with sufficient corrosion-protection and corrosion-resistance at all, whereas the upper limits are due to the fact that above a certain thickness, no enhancements of the corrosion-protection or corrosion-resistance can be reached; but nevertheless, it might be possible to deviate from the afore-mentioned limits if this is required according to applicational necessities.

In a preferred embodiment, the metal oxide layer is a TiO₂-layer. Applicant has surprisingly found that a TiO₂-layer leads to the best results with respect to corrosion-protection and corrosion-resistance, especially when considering the relatively little layer thickness (in comparison with the analogous ZnO— and Bi₂O₃-layers). In order to provide the metal substrate with sufficient corrosion-protection/corrosion-resistance, the minimum layer thickness of the TiO₂-layer, to be deposited on said metal substrate with an essentially uniform layer thickness, should be at least 0.01 g/m², preferably at least 0.05 g/m², more preferably at least 0.1 g/m², calculated as weight per unit area. For sufficient corrosion-protective properties, the maximum layer thickness of said TiO₂-layers, applied as an essentially uniform layer and calculated as weight per unit area, can be, at maximum, up to 3.5 g/m², desirably less than up to 3.0 g/m², preferably less than up to 1.5 g/m², more preferably less than up 1.0 g/m².

Preferably, the TiO₂-layer may be deposited on said metal substrate with an essentially uniform layer thickness, calculated as weight per unit area, in the range of from 0.01 to 3.5 g/m², preferably in the range of from 0.5 to 1.4 g/m². For, applicant has surprisingly found that a range of from 0.5 to 1.4 g/m², calculated as weight per unit area, leads to optimum results with respect to corrosion-protection and corrosion-resistance: Values falling below 0.5 g/m² lead to sufficient and good, but non-optimum corrosion-protection, whereas with values exceeding 1.4 g/m² corrosion-protection and corrosion-resistance slightly decreases again in comparison with the range of from 0.5 to 1.4 g/m². Without being bound to any theory, the latter phenomenon might be possibly ascribed to the fact that when greater thicknesses of the TiO₂-layer than 1.4 g/m² are coated/deposited on said metal substrate, slight cracks might occur in the metal oxide cover layer, which might explain the surprising phenomenon that with values exceeding 1.4 g/m² corrosion-protection and corrosion-resistance is still sufficient and excellent but slightly deteriorated in comparison with the range of from 0.5 to 1.4 g/m². Thus, with respect to TiO₂-layers, the range of from 0.5 to 1.4 g/m² provides the best results.

Electrochemical deposition is performed according to a method known per se to the skilled practitioner:

The metal substrate to be coated with said metal oxide layer is contained in an electrolytic bath containing an appropriate precursor salt of the metal oxide to be deposited, said precursor salt being soluble in said electrolytic bath and being electrochemically depositable as a metal oxide. For instance, in the case of TiO₂-layers to be deposited on a metal substrate, Ti (IV) compounds/salts may be used as precursor salts, such as e.g. titanium (IV) halides and titanium (IV) oxyhalides, such as TiCl₄ and TiOCl₂, or other titanium (IV) compounds producing TiO²⁺ species in the electrolytic bath, such as e.g. titanyl sulfate TiOSO₄, titanyl oxalate, etc. For instance, in the case of Bi₂O₃-layers to be deposited on a metal substrate, e.g. bismuth nitrates, such as e.g. Bi(NO₃)₃ or BiO(NO₃), might be used as appropriate precursor salts. In the case of ZnO-layers to be deposited on a metal substrate, e.g. zinc (II) sulfates or nitrates, i.e. ZnSO₄ and Zn(NO₃)₂, might be used as appropriate precursor salts. All precursor salts to be used should be soluble in the respective electrolyte under the respective process/deposition conditions.

Apart from the presence of the precursor salt to be deposited as the metal oxide layer on said metal substrate, the electrolytic bath further comprises at least one conducting salt. As a conducting salt, the compounds generally used for this purpose and known in the prior art may be utilized, for example nitrates, such as e.g. sodium or potassium nitrate, but also sulfates, perchlorates, etc. Apart from this, the electrolytic bath may optionally contain one or more additives or aids as known per se in the prior art; such additives or aids may, for example, be selected from the group consisting of: Stabilizers; complexing or sequestering agents, such as chelating agents (chelators), e.g. citrate or citric acid, tartric acid and tartrates, lactic acid and lactates, etc.; accelerators or promoting agents such as hydroxylamines and their derivatives, such as e.g. N-methylhydroxylamine, hydroxylaminesulfate and the like, or nitrates, etc.; buffering agents; and the like.

Advantageously, electrochemical deposition is performed in an essentially peroxide-free electrolyte. The absence of peroxides is advantageous insofar as the composition of the electrolytic bath is less complex on the one hand and, on the other hand leads to an eased manageability. Nevertheless, it is not excluded to use minor amounts of peroxide as accelerating or promoting agents, preferably in combination with N-morpholine-N-oxide; however, in this case the peroxide contained in the electrolytic bath should be limited to a minimum amount, preferably less than 1% by weight (based on the electrolyte), even less than 0.5% by weight, preferably less than 100 ppm, more preferably in amounts of from 30 ppm to 50 ppm. Advantageously, according to a preferred embodiment of the present invention, however, the electrolytic bath is essentially peroxide-free. For, as applicant has surprisingly found, the further crucial advantage of the absence of peroxides is the fact that the process according to the present invention being performed in a peroxide-free or in an essentially peroxide-free electrolytic bath is also applicable to technical steels of all kinds whereas prior art electrochemical deposition from a peroxide-containing electrolytic bath is not possible on technical steels.

Further, the electrolyte for the electrochemical deposition reaction should be essentially free of halides, especially chlorides and fluorides. For, applicant has surprisingly found that the presence of halides (e.g. chlorides) deteriorates the anti-corrosive properties of the coated metal substrate and even promotes corrosion. Thus, the maximum amount of chlorides should be less than 10⁻³ g/l, preferably less than 10⁻⁴ g/l, more preferably less than 10⁻⁵ g/l, in the electrolytic bath. The same applies to the fluoride content, which should also be within these limits (i.e. less than 10⁻³ g/l, preferably less than 10⁻⁴ g/l, more preferably less than 10⁻⁵ g/l, in the electrolytic bath).

The process according to the present invention is normally performed at pH-values ≦7, desirably in the range of from 1 to 7, preferably of from 5 to 7, more preferably at pH-values of about 6. An only slightly acidic pH-value of about 6 is particularly preferred because such an electrolytic bath is easy to handle and not corrosive. Therefore, slightly acidic pH-values are particularly preferred. Slightly acidic pH-values are also preferred due to the solubility of the precursor salts (e.g. titanyl salts) to be deposited. Nevertheless, it is possible to run the inventive process also under neutral or even slightly alkaline conditions, although acidic conditions are preferred; thus, the process of the present invention can be performed at pH-values ≦10 (e.g. in the range of from 4 to 9), however, with the proviso that the precursor salt, the oxide of which is to be deposited on a metal substrate, is still soluble or at least partially soluble in the respective electrolyte in sufficient amounts or does not precipitate, respectively (The solubility might e.g. also be influenced by the addition of certain additives/aids, particularly complexing agents.).

Generally, an aqueous or water-based electrolyte is used, which is very positive with respect to environmental aspects; although the use of tap water is possible (provided that the halide content lies within the above limits), the use of demineralized or de-ionized water is preferred for the electrolyte.

Electrochemical deposition may be run in a manner known per se to the skilled practitioner: Electrochemical deposition may be run galvanostatically or potentiostatically; however, galvanostatic proceeding is preferred. The metal substrate to be coated with a metal oxide layer may be used as a cathode dipping into the electrolytic bath. Usually, current densities, particularly cathodic current densities, of between 0.02 and 100 mA/cm², preferably 0.1 and 10 mA/cm², can be used. The potential (voltage), especially the cathodic potential, usually lies in the range of between −0.1 and −5 V, preferably −0.1 and −2 V, referred to a normal hydrogen electrode.

The process according to the present invention has the decisive advantage that it leads to abrasion-resistant, dense and compact metal oxide layer on the metal substrate to be provided with anti-corrosive properties without any subsequent heat-treatment, such as sintering, calcining or the like. The metal oxide layers obtained according to the process of the present invention can be directly used for the respective applications for which they are intended.

The high abrasion-resistance of the metal oxide coatings obtained according to the process of the present invention is mainly due to the high crystallinity which these metal oxide layers possess: In general, the overall degree of (poly)crystallinity exhibits more than 30%, desirably more than 40%, preferably more than 45%, more preferably more than 50% and even higher values. In the case of TiO₂-layers, the crystalline structures comprise anatase, rutile and/or brookite structures. These polycrystalline TiO₂-structures possess a high mechanical strength and abrasion-resistance. Due to the high degree of crystallinity, such layers possess photocatalytic activity.

TiO₂-layers are particularly preferred since their thickness, if compared to the thicknesses of the Bi₂O₃— and ZnO-layers, is relatively thin so that the weight of the metal substrate is only slightly influenced.

The metal oxide layer obtained according to the inventive process may, at the same time, serve as a primer for subsequent coating treatment, such as coating with organic materials, such as, for instance, lacquers, varnishes, paints, organic polymers, adhesives, etc. For instance, the metal oxide layer obtained according to the inventive process is an excellent primer for cathodic electropaint (CEP) or coil-coating.

The process according to the present invention leads to a great number of advantages:

The process according to the present invention replaces the conventional processes of e.g. phosphating, chromating or chromium-free conversion treatment, which are often related to great environmental problems and have to be performed in several sub-steps. On the contrary, the process according to the present invention is compatible with respect to environmental requirements and renounces the use of heavy metals and halides such as chlorides and fluorides.

Furthermore, the process of the present invention has the decisive advantage to be performed as a one-step process without any subsequent treatment steps (e.g. heat-treatment). Preferably, the inventive process may be performed in only one step.

Furthermore, the inventive process is applicable on conductive metal substrates of nearly all kinds. For instance, the inventive process is even applicable on technical steel. In contrast to this, prior art deposition techniques from peroxide-containing electrolytes cannot be applied to technical steel.

The process according to the present invention renounces any activation before electrochemical deposition. If necessary, only the step of degreasing the metal substrate surface to be coated prior to electrodeposition may be performed as a pre-treatment. In certain cases, the step of degreasing might be necessary or required in order to obtain an optimum adhesion of the metal oxide layer on the metal substrate to be coated.

In addition, the inventive process is performed in an electrolyte that is especially environmentally friendly (absence of peroxides, absence of halides such as chlorides and fluorides, absence of heavy metals, no occurrence of sludge, etc.).

The process according to the present invention leads to abrasion-resistant metal oxide films on any conductive substrates, regardless of the substrate material.

The process according to the present invention allows an easy control of the thickness of the metal oxide layers obtained. Due to the high (poly)crystallinity of the obtained metal oxide films/layers, they are particularly abrasion-resistant and provide the metal substrate coated with excellent anti-corrosive properties and, at the same time, serve as a primer layer for subsequent coating treatments as explained above.

The present invention which renders possible the preparation of metal oxide layers, especially TiO₂-layers, by electrochemical reaction, has solved several problems related to the known prior art processes mentioned above:
The existence of TiO²⁺ ions in the electrolyte exhibits that TiO₂-layers with crystal structure, such as anatase, rutile and/or brookite structures, are obtained on conductive metal substrates such as aluminum sheets, stainless sheets, titanium sheets, NESA-glass, etc., at low substrate temperature without subsequent heat-treatment (such as e.g. heating, sintering, calcining, etc.).
The preparation of the TiO₂-layers may be carried out by using a potentio/galvanostat.
The appropriate electrolyte provides growth of the TiO₂-layer on conductive metal substrates of all kinds, regardless of substrate material.
Control of thickness for TiO₂-layer is easily handled.
The range of pH-values is relatively large, although slightly acidic conditions are preferred.
In order to grow TiO₂-layers from titanium ions, electrolytes without peroxides, hydrofluoric acid or aqueous ammonia are used according to the invention. The complex between TiO²⁺ ion and complexing agent (e.g. citric acid or its salt) exists within the electrolyte. Thus, this electrolyte is more environmentally friendly and has high stability.
For electrochemical growth of TiO₂, hydroxylamine groups (NH₂OH, N-methyl-hydroxylamine, etc.) play an important role to grow polycrystalline TiO₂-layer and to increase the deposition rate.

On the whole, according to the present invention, especially TiO₂-layers with highly (poly)crystalline structures, such as anatase, rutile and/or brookite structures, may be obtained on conductive metal substrate by a one-step process without subsequent heat-treatment. The electrochemical deposition reaction leads to the growth of polycrystalline TiO₂-layers on conductive metal substrates, regardless of the respective substrate materials. A typical composition of an electrolyte for producing TiO₂-layers comprises e.g. titanyl sulfate or titanyl potassium oxalate dihydrate aqueous solution further containing a conducting salt (e.g. sodium nitrate) and optionally other additive/aids, such as e.g. complexing agents (e.g. citric or lactic acid or their salts), accelerators or promoters/activators (e.g. hydroxylamines, etc.).

According to the second aspect of the present invention, the present invention also relates to the products obtainable according to the process of the present invention, i.e. conductive metal substrates provided with a corrosion-protection or corrosion-resistance, respectively, wherein said metal substrate is coated on at least one surface with an abrasion-resistant and dense, compact layer of at least one metal oxide selected from the group consisting of TiO₂, Bi₂O₃ and ZnO, preferably TiO₂, said metal oxide layer being electrochemically deposited on said metal substrate. For further details with respect to the products of the present invention, i.e. the coated metal substrates, reference can be made to the preceding explanations with respect to the process of the present invention, which also apply to the products of the present invention accordingly.

Optimum results, i.e. optimum anti-corrosive properties, are obtained when said metal oxide layer is a TiO₂-layer deposited on said metal substrate with an essentially uniform thickness, desirably with a layer thickness, calculated as weight per unit area, in the range of from 0.01 to 3.5 g/m², preferably in the range of from 0.5 to 1.4 g/m². These layers are relatively thin, if compared to the analogous ZnO-layers and Bi₂O₃-layers, and nevertheless provide an optimum corrosion-protection, especially due to the relatively high polycrystallinity of the metal oxide layer. As explained in detail above, said metal substrate may be any conductive metal substrate. For instance, such conductive metal substrate may be selected from the group consisting of iron, aluminum, magnesium and their alloys and mixtures, preferably steel of all kinds, such as technical steel, galvanized steel, cold-rolled steel, etc.

Finally, according to a third aspect of the invention, the present invention relates to the use of a metal oxide layer coated on a conductive metal substrate as an anti-corrosive and/or corrosion-resistant layer and/or as a primer for subsequent coating, wherein said metal oxide layer is electrochemically deposited on at least one surface of said metal substrate as an abrasion-resistant and dense, compact coating layer, wherein said metal oxide of said metal oxide layer is selected from the group consisting of TiO₂, Bi₂O₃ and ZnO, preferably TiO₂. For further details with respect to the inventive use, reference can be made to the preceding explanations with respect to the process of the present invention, which also apply to the inventive use accordingly.

Further embodiments, aspects, variations and advantages of the present invention will be understood by the skilled practitioner when reading the description, without him leaving the scope of the present invention. The present invention will be illustrated by the following Examples, which, however, do not limit the present invention.

### EXAMPLES

Examples for preparation of TiO₂-layers (TiO₂-films) by electrochemical deposition/reaction are shown in the following.

### Example 1

### Example 1-1

TiO₂-layers were electrochemically grown from titanyl sulfate aqueous solution with sodium nitrate and sodium tartrate at cathodic potentials of −0.8 V, −1.0 V and −1.2 V, respectively. Titanyl sulfate concentration was 0.1 mol/L. Sodium tartrate concentration was 0.1 mol/L. Sodium nitrate concentration was 0.1 mol/L. A titanium sheet (99.999% purity) was used as an active anode. An Ag/AgCl-electrode was used as a reference. Electrolysis was carried out potentiostatically using a potentio/galvanostat (Hokuto Denko, HABF501) without stirring. Table 1-1 shows the electrochemical deposition conditions for the TiO₂-layers of Example 1-1.

TABLE 1-1
Electrochemical growth conditions
for the TiO₂-layers of Example 1-1

| | |
|---|---|
| Composition of the electrolyte | |
| Titanyl sulfate concentration | 0.1 mol/L |
| Sodium tartrate concentration | 0.1 mol/L |
| Sodium nitrate concentration | 0.1 mol/L |
| Anode electrode | titanium sheet (99.999%) |
| Substrate (cathodic electrode) | NESA-glass |
| Referring electrode | Ag/AgCl |
| pH for the electrolyte | pH = 6 |
| Deposition conditions | |
| Electrolysis | Potentiostatic method |
| Cathodic potential | −0.8 V |
| | −1.0 V |
| | −1.2 V |
| Coulomb value | 10 C/cm² |
| Deposition temperature | 333 K |

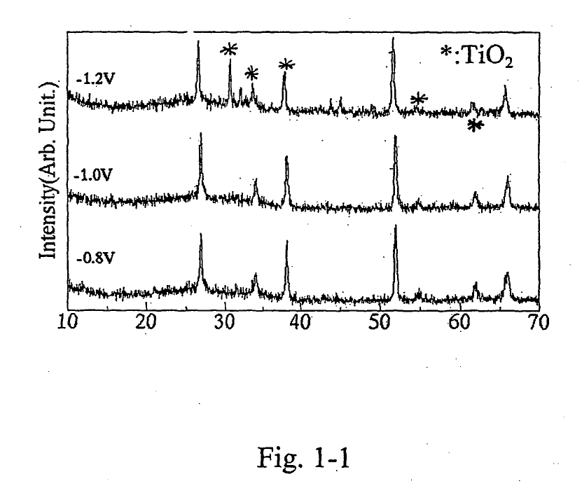

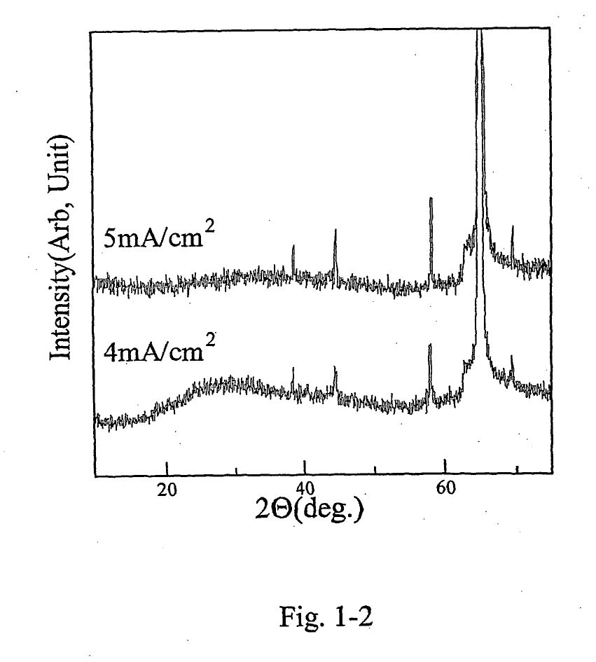

The optical property for the TiO₂-layers was measured by ultraviolet-visible spectroscopy (UV-VIS). The structural property for the TiO₂-layers was evaluated by X-ray diffraction measurements, performed with Philips PW3050 using monochromated Cu—Kα-radiation operated at 40 kV and 30 mA. FIG. 1-1 shows the XRD spectra for the TiO₂-layers of Example 1-1 electrochemically obtained on NESA-glass. All diffraction lines were identified to those of TiO₂. The surface morphology and sectional structure of the TiO₂-layers of Example 1-1 were observed by using a scanning electron microscopy (SEMEDX TYPE N, Hitachi S3000N). Photocatalytic activities of the TiO₂-layers were evaluated by using the oxidation reaction rate constant of acetaldehyde (CH₃CHO). Oxidation reaction rate constants were calculated by measuring acetaldehyde (CH₃CHO) concentration in a 3.3 L reaction glass chamber containing these TiO₂-layers. The acetaldehyde concentration was measured by a gas chromatograph (GC-14B, Shimadzu) under the dark and UV-illumination with 2 mWcm⁻² (300 W Xe-lamp, Wacom model XDS-301S) at room temperature. For the TiO₂-layers electrochemically obtained on conductive substrates at cathodic potential of −1.0 V, the oxidation reaction rate of CH₃CHO was 0.042 h⁻¹ (=k). For TiO₂-layers with anatase structure electrochemically obtained on conductive substrates at cathodic potential of −0.8 V, the oxidation reaction rate of CH₃CHO was 0.021 h⁻¹ (=k). The TiO₂-layers with rutile structure electrochemically obtained on conductive substrate have photocatalytic activity. In contrast to this, TiO₂-layers with amorphous structure do not have photocatalytic activity (k=0 h⁻¹).

### Example 1-2

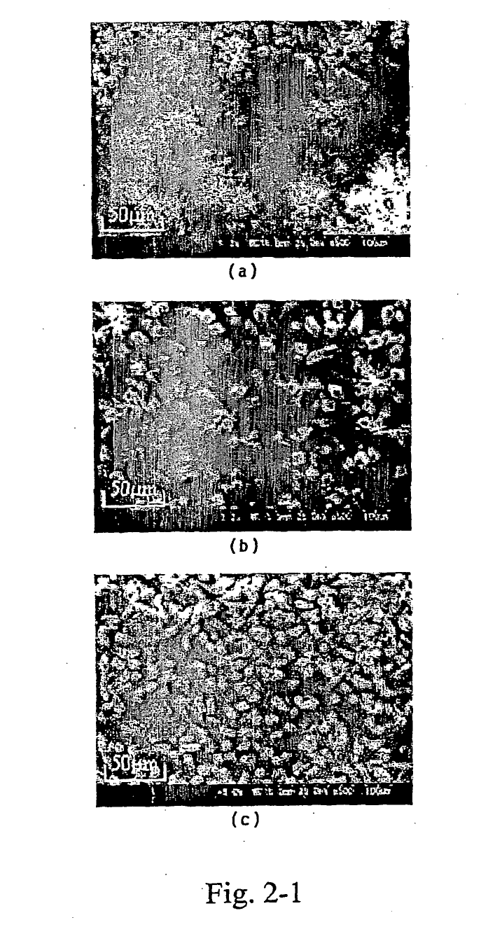

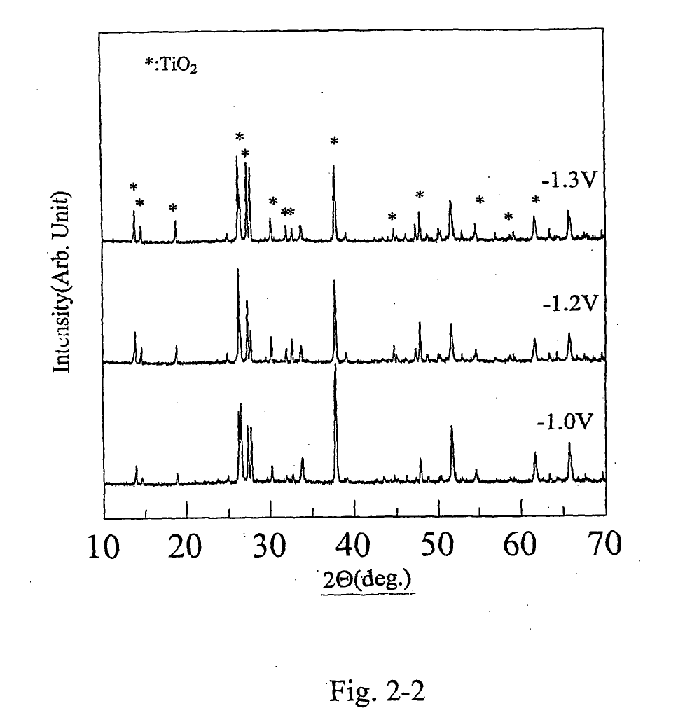

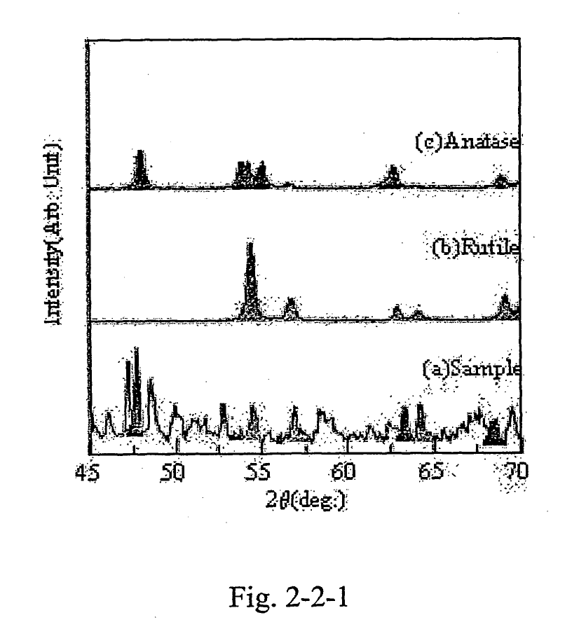

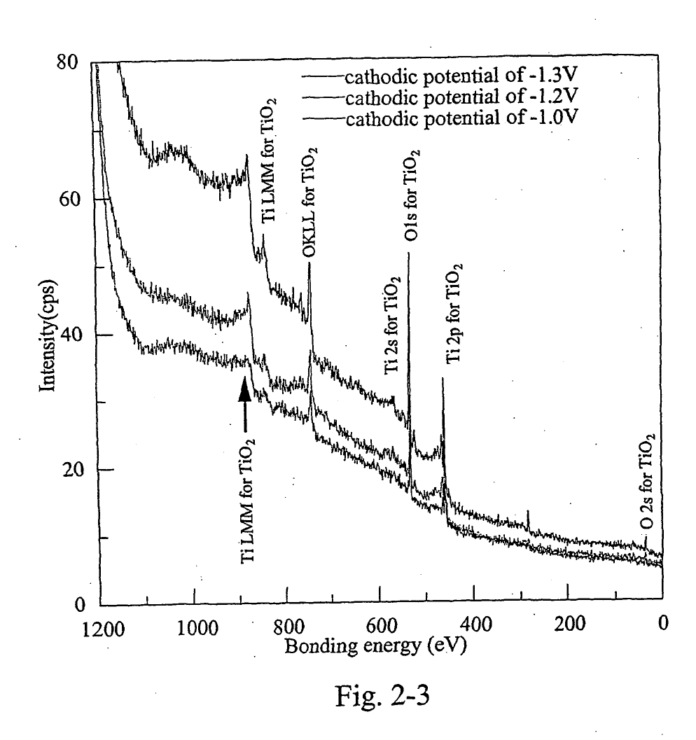

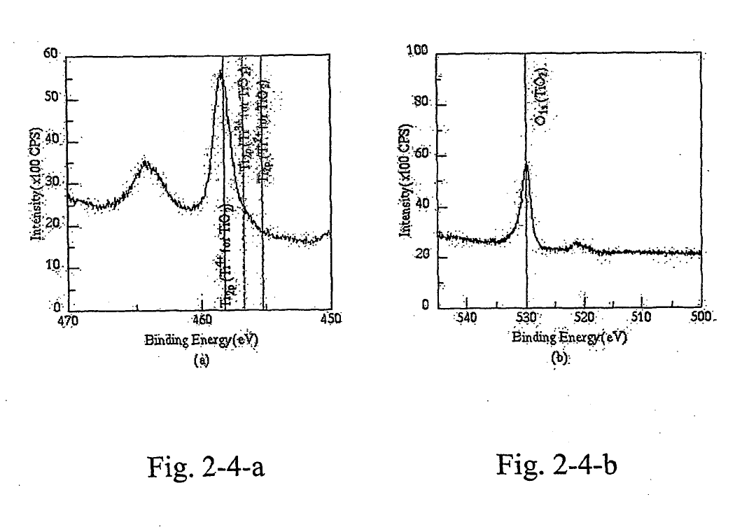

On aluminum sheet, TiO₂-layers were electrochemically grown by using the electrolyte and the equipment mentioned above. A titanium sheet (99.999%) was used as the active anode, and an Ag/AgCl-electrode was used as a reference. Electrolysis was performed by using potentio/galvanostat (Hokuto Denko, HABF501) without stirring at −4 mA/cm² and −5 mA/cm² cathodic current density. The Coulomb values were constant values of 10 C/cm², regardless of all electrochemical growth conditions. Table 1-2 shows the electrochemical deposition conditions for the TiO₂-layers of Example 1-2. FIG. 1-2 shows the X-ray diffraction spectra of the TiO₂-layers off Example 1-2 galvanostatically obtained. All diffraction lines were identified to those of TiO₂.

TABLE 1-2
Electrochemical growth conditions
for the TiO₂-layers of Example 1-2

| | |
|---|---|
| Composition of electrolyte | |
| Titanyl sulfate concentration | 0.1 mol/L |
| Sodium tartrate concentration | 0.1 mol/L |
| Sodium nitrate concentration | 0.1 mol/L |
| Anode electrode | titanium sheet (99.999%) |
| Substrate (cathodic electrode) | Al sheet (99.999%) |
| Referring electrode | Ag/AgCl |
| pH for the electrolyte | pH 9 |
| Deposition conditions | |
| Electrolysis | Galvanostatic method |
| Current density | −4 mA/cm² |
| | −5 mA/cm² |
| Coulomb value | 10 C/cm² |
| Deposition temperature | 333 K |

### Example 2

In Example 2, polycrystalline TiO₂-layers were electrochemically grown on NESA-glass substrates from a 0.05 M titanium potassium oxalate dihydrate aqueous solution containing a 0.5 M hydroxylamine at 333 K by cathodic potentiostatic methods. The electrolytes were adjusted to pH=9 with KOH (aq.). A titanium sheet (99.999%) was used as active anode, and an Ag/AgCl-electrode was used as a reference. Electrolysis was performed by using potentiostatic/galvanostatic (Hokuto Denko, HABF501) without stirring at cathodic potential range of −1.3 V to −1.0 V. The Coulomb values were constant values of 10 C/cm², regardless of all electrochemical growth conditions. Table 2-1 shows the electrochemical deposition conditions for the TiO₂-layer of Example 2.

TABLE 2-1
Electrochemical growth conditions
for the TiO₂-layers of Example 2

| | |
|---|---|
| Composition of electrolyte | |
| Titanium potassium oxalate | 0.05 mol/L |
| dihydrate concentration | |
| Hydroxylamine concentration | 0.5 mol/L |
| Anode electrode | titanium sheet (99.999%) |
| Substrate (cathodic electrode) | NESA-glass |
| Referring electrode | Ag/AgCl |
| pH for this electrolyte | pH 9 |
| Deposition conditions | |
| Electrolysis | Potentiostatic method |
| Cathodic potential | −1.0 V |
| | −1.2 V |
| | −1.3 V |
| Coulomb value | 10 C/cm² |
| Deposition temperature | 333 K |

Surface morphology for the TiO₂-layers of Example 2 with a thickness of about 50 μm were observed by using a scanning electron microscopy (SEMEDX TYPE N, Hitachi S3000N). FIG. 2-1 shows the effect of surface morphology for these TiO₂-layers of Example 2 on cathodic potential (FIG. 2-1(a): cathodic potential of −1.3 V; FIG. 2-1(b): cathodic potential of −1.2 V; FIG. 2-1(c): cathodic potential of −1.0 V). The TiO₂-layers of Example 2 were composed of aggregates of tetragonal grains, regardless of cathodic potential. The grain size of these TiO₂-layers decreased with a decrease in the cathodic potential.

Structural properties for the TiO₂-layers of Example 2 were evaluated by X-ray diffraction measurements, performed with a Philips PW3050 using monochromated Cu—Kα-radiation operated at 40 kV and 30 mA. FIG. 2-2 shows the dependence of cathodic potential on XRD spectra of the TiO₂-layers of Example 2. All diffraction lines were identified to those of TiO₂. In order to calculate the anatase and rutile crystallinity in the TiO₂-layer of Example 2 formed at cathodic potential of −1.3 V, TiO₂-powder from this TiO₂-layer on NESA-glass was obtained by separating the TiO₂-layer from NESA-glass. The calculation of crystallinity is discussed in detail, below. Since peak containing non-crystal and crystal was observed at low 2Θ(20 deg.-40 deg.), the evaluation of the crystallinity for this sample was carried out at high 2Θ(45 deg.-70 deg.). The crystallinity was calculated by using the following equation (1):
Crystallinity for sample=ΣIₛₐₘₚₗₑ/ΣI_{pure crystal}×100 (%) (1)
where I_{pure crystal} is the line intensity for the peak of pure crystal sample observed at 2Θ ranging of 40 deg. to 70 deg. and Iₛₐₘₚₗₑ is the line intensity for the peak of a sample observed at the same peak for pure crystal sample. The line intensity ratio of these values corresponds to the percentage of the crystalline form (cf. B. D. Cullity, “Elements of X-Ray Diffraction”, Prentice Hall, (2003)). The first assumption was that the line intensity in the XRD spectrum was proportional to the amount of the particular crystalline material present in the sample. The peak to be used for this had to be a unique peak for each crystalline form. Thus, by measuring the XRD of pure crystalline rutile (see FIG. 2-2-1(b)) and anatase (see FIG. 2-2-1(c)), the intensity of the peak characteristic to the crystalline form was measured (integrated).

Then the XRD of the test sample (FIG. 2-2-1(a), TiO₂ obtained at cathodic potential of −1.3 V) was measured and the intensity of the particular peak was measured. The crystallinity of the sample was calculated by using equation (1). This TiO₂ sample of Example 2 obtained at cathodic potential of −1.3 V had anatase crystallinity of 32.5% and rutile crystallinity of −20.1%.

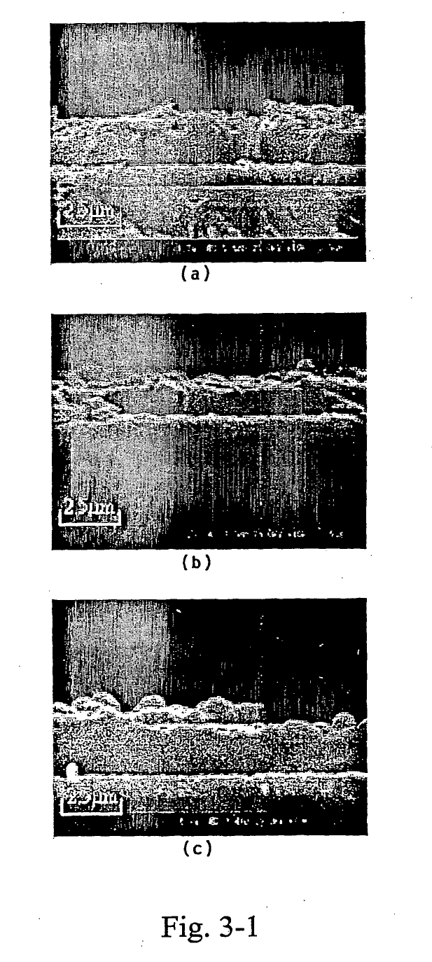

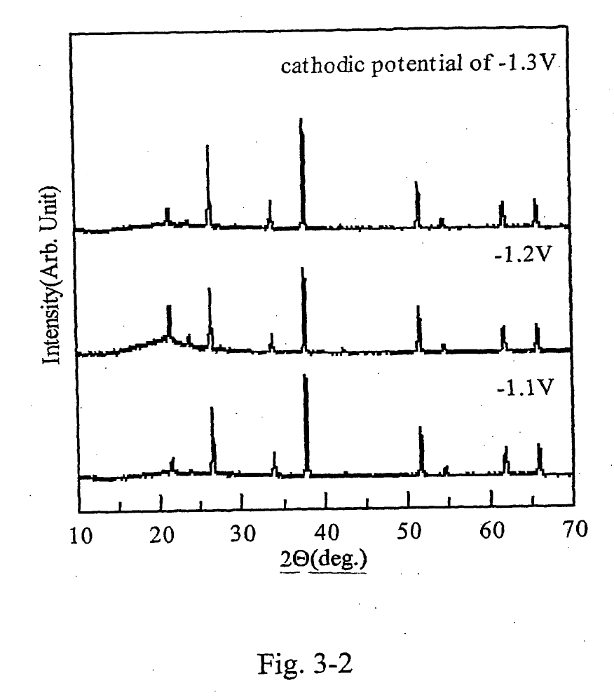

X-ray photoelectron spectra of the TiO₂-layers of Example 2 were observed by using X-ray photoelectron spectroscopy (ESCA-850, Shimazu). FIG. 2-3 shows the X-ray photoelectron spectra of the TiO₂-layers of Example 2 electrochemically obtained on conductive substrate (middle curve: cathodic potential of −1.3 V; lower curve: cathodic potential of −1.2 V; upper curve: cathodic potential of −1.0 V). All peaks were identified to those of TiO₂. FIG. 2-4 shows the Ti₂ₚ electron spectrum (FIG. 2-4(a)) and the O₁ₛ electron spectrum (FIG. 2-4(b)) for the TiO₂-layer of Example 2 electrochemically deposited at cathodic potential of −1.3 V. For FIG. 2-4(a), the peak of the Ti₂ₚ spectrum was obtained at vicinity of 458.235 eV corresponding to that for Ti⁴⁺ for the TiO₂ envelope. Referring to the XPS spectrum of that TiO₂-layer, the peak of the Ti₂ₚ spectrum for Ti²⁺ and Ti³⁺ was not observed. Thus, adding hydroxylamine into a titanium potassium oxalate dihydrate aqueous solution exhibited that the Ti³⁺ would oxidize.

For FIG. 2-4(b), the peak of O₁ₛ spectrum was obtained at vicinity of 529.9 eV corresponding to that for O₁ₛ, for the TiO₂ envelope. However, the peak for oxygen deficiency of the TiO₂-layer of Example 2 could not be observed at 527 eV for these XPS spectra of O₁ₛ electron spectra. The electrochemical growth of the TiO₂-layer of Example 2 exhibited that oxygen deficiency was not present in the TiO₂-layers.

Thus, hydroxylamine played an important rule to grow polycrystalline TiO₂-layers. Photocatalytic activities of the TiO₂-layers were evaluated by using the oxidation reaction rate constant of acetaldehyde (CH₃CHO) (S. Ito et. al., J. Electrochem. Soc., 440 (1999)). The oxidation reaction rate constants were calculated by measuring acetaldehyde (CH₃CHO) concentration in a 3.3 L reaction glass chamber containing the TiO₂-layers of Example 2. The acetaldehyde concentration was measured by a gas chromatograph (GC-14B, Shimadzu) under the dark and the UV-illumination with 2 mWcm⁻² (300 W Xe-lamp, Wacom model XDS-301S). The TiO₂-layers of Example 2 have oxidation reaction rate constants of 0.0929/h, 0.0536/h and 0.0299/h for cathodic potentials of −1.3 V, −1.2 V and −1.0 V, respectively. This indicates that TiO₂-layers obtained at all cathodic potentials have photocatalytic activity and the photocatalytic activity of TiO₂-layers increases with a decrease in cathodic potential.

### Example 3

Polycrystalline TiO₂-layers of Example 3 were electrochemically grown on NESA-glass substrates from a 0.05 M titanium potassium oxalate dihydrate aqueous solution containing a 0.5 M N-methylhydroxylamine at 333 K by cathodic potentiostatic methods. The electrolyte was adjusted to pH=9 with KOH (aq.). A titanium sheet (99.999%) was used as the active anode; and an Ag/AgCl-electrode was used as a reference. Electrolysis was performed by using potentio/galvanostat (Hokuto Denko, HABF501) without stirring at cathodic potential range of −1.3 V to −1.1 V. The Coulomb values were constant values of 10 C/cm², regardless of all electrochemical growth conditions. Table 3-1 shows the electrochemical deposition conditions for the TiO₂-layer of Example 3.

TABLE 3-1
Electrochemical growth conditions
for the TiO₂-layers of Example 3

| | |
|---|---|
| Composition of electrolyte | |
| Titanium potassium oxalate | 0.05 mol/L |
| dihydrate concentration | |
| Methylhydroxylamine concentration | 0.5 mol/L |
| Anode electrode | titanium sheet (99.999%) |
| Substrate (cathodic electrode) | NESA-glass |
| Referring electrode | Ag/AgCl |
| pH for this electrolyte | pH 9 |
| Deposition conditions | |
| Electrolysis | Potentiostatic method |
| Cathodic potential | −1.0 V |
| | −1.2 V |
| | −1.3 V |
| Coulomb value | 10 C/cm² |
| Deposition temperature | 333 K |

Surface morphology and cross-section morphology for the TiO₂-layers of Example 3 were observed by using a scanning electron microscopy (SEMEDX TYPE N, Hitachi S3000N). The cross-section morphology for the TiO₂-layers of Example 3 is shown in FIG. 3-1 (FIG. 3-1(a): cathodic potential of −1.3 V; FIG. 3-1(b): cathodic potential of −1.2 V; FIG. 3-1(c): cathodic potential of −1.1 V). These layers had thickness of about 25 μm, regardless of cathodic potential.

Structural properties for the TiO₂-layers of Example 3 were evaluated by X-ray diffraction measurements mentioned in Examples 1 and 2. FIG. 3-2 shows the dependence of cathodic potential on the XRD spectra of the TiO₂-layers of Example 3. All diffraction lines were identified to those of TiO₂. The diffraction lines for other compounds such as nitride compounds and others were not observed.

### Example 4

The electrolytes for TiO₂-layer generation were composed of 0.05 mol/L titanyl sulfate, 0.05 mol/L citric acid and 1 mol/L hydroxylamine. From this electrolyte, kept at 333 K, the TiO₂-layers were electrochemically prepared on a conductive substrate (NESA-glass) at cathodic potential range of −1.4 V to −1.0 V. A titanium sheet (99.999%) was used as active anode; and an Ag/AgCl-electrode was used as a reference. Electrolysis was performed by using potentio/galvanostat (Hokuto Denko, HABF501) without stirring at cathodic potential ranging of −1.3 V to −1.1 V. The Coulomb values were a constant value of 10 C/cm², regardless of all electrochemical growth conditions. Table 4-1 shows the electrochemical deposition conditions for the TiO₂-layer of Examples 4-1 and 4-2.

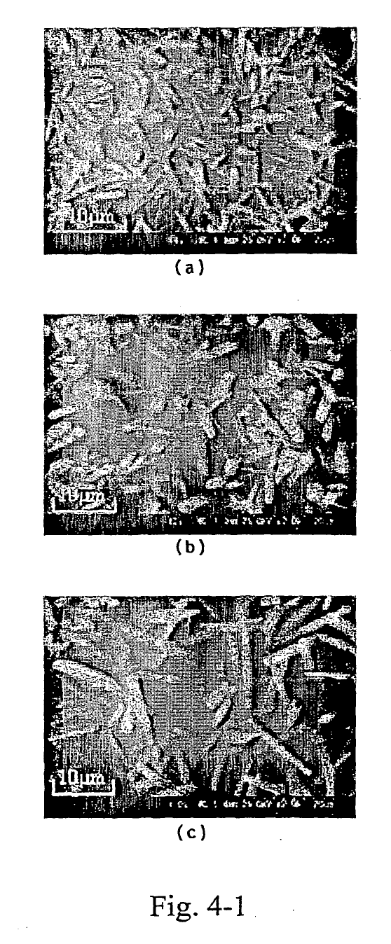

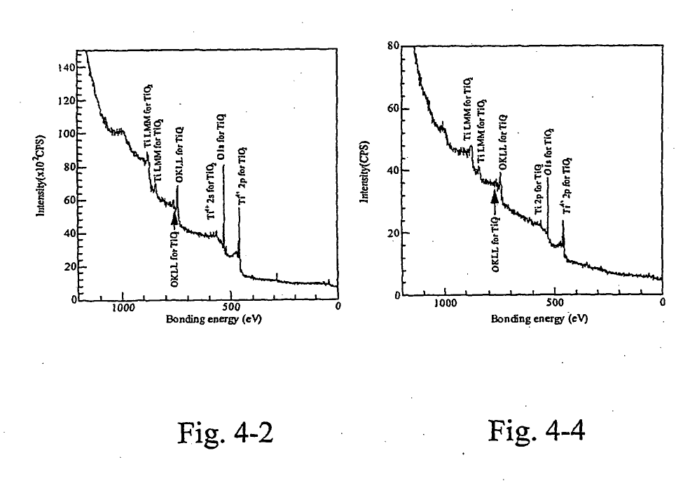

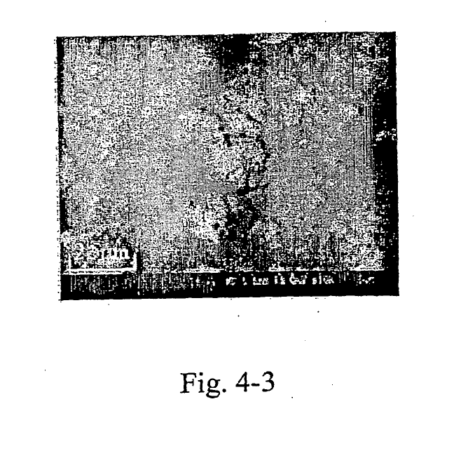

For Example 4-1, the case of electrochemical deposition without stirring, surface morphology and XPS spectrum for the TiO₂-layer are shown in the respective figures. FIG. 4-1 shows the surface morphology for the TiO₂-layers of Example 4-1 (FIG. 4-1(a): cathodic potential of −1.4 V; FIG. 4-1(b): cathodic potential of −1.2 V; FIG. 4-1(c): cathodic potential of −1.0 V). The TiO₂-layers of Example 4-1 were composed of aggregates of tetragonal grains, regardless of cathodic potential. X-ray photoelectron spectra of the TiO₂-layers of Example 4-1 were observed by using X-ray photoelectron spectroscopy (ESCA-850, Shimazu). FIG. 4-2 shows the X-ray photoelectron spectra of these TiO₂-layers electrochemically obtained on a conductive substrate at a cathodic potential of −1.0 V. All peaks were identified to those of TiO₂.

For Example 4-2, the case of electrochemical deposition with stirring, surface morphology and XPS spectrum for the TiO₂-layer were shown in the respective figures. FIG. 4-3 shows the surface morphology for the TiO₂-layers of Example 4-2 electrochemically grown at cathodic potential of −1.0 V. The TiO₂-layers were composed of aggregates of spherical grains. Compared with the surface morphology for Example 2, this TiO₂-layer has smooth surface. X-ray photoelectron spectra of the TiO₂-layers of Example 4-2 were observed by using X-ray photoelectron spectroscopy (ESCA-850, Shimazu). FIG. 4-4 shows the X-ray photoelectron spectra of the TiO₂-layer of Example 4-2 electrochemically obtained at cathodic potential of −1.0 V. All peaks were identified to those of TiO₂. Thus, stirring exhibits the decrease in roughness of the TiO₂-layer.

Thus, applicant succeeded in electrodepositing, on conductive substrates, anticorrosive TiO₂-layers with excellent corrosion-resistance and, due to the high degree of polycrystallinity, also with photocatalytic activity without (subsequent) heat-treatment (such as drying, calcining or sintering). Although in the preceding Examples only titanium sheets were used as counter-electrodes, also other electrode materials known per se (as far as appropriate and compatible with respect to the process according to the present invention) may be used (such as e.g. carbon, platinum, gold, steel, etc.)

In an analogous way, metal oxide layers based on ZnO and Bi₂O₃ were obtained. The respective experimental data were given in the attached Tables 5 and 6.

Corrosion Test:

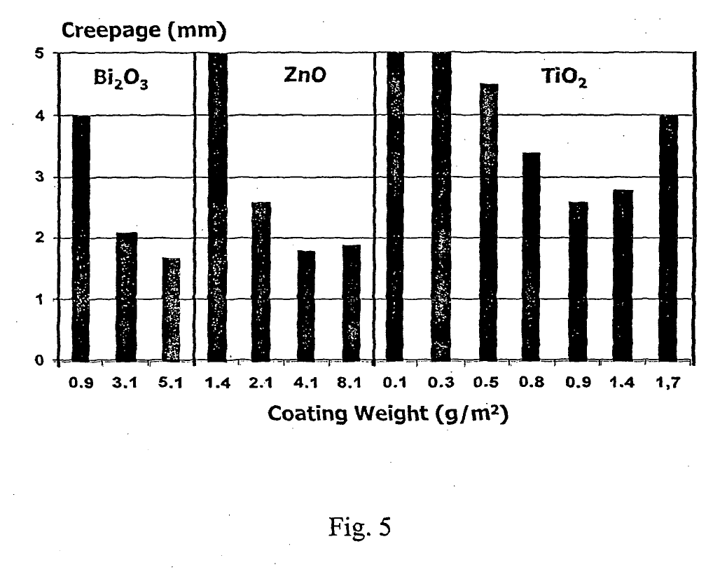

Samples produced according to the process of the present invention were subjected to a corrosion test series. In said corrosion tests (10 cycles of VDA cyclic corrosion test, cathodic electropaint-coating), steel-plates coated with Bi₂O₃, ZnO or TiO₂, respectively, with different layer thicknesses were tested: The test results are reflected in the attached FIG. 5. As it can be seen from these figures, all metal oxide layers tested (TiO₂, Bi₂O₃, ZnO) led to improved anti-corrosive properties. Relative to the layer thickness, TiO₂-coating layers led to the best results with relatively little thicknesses in the respective layers if compared to analogous Bi₂O₃— or ZnO-layers. With respect to TiO₂-layers, the range of from 0.5 to 1.4 g/m² provides the best results; Surprisingly, increasing the layer thickness of the TiO₂-coatings over a certain value (1.4 g/m²) led to a slight deterioration of anti-corrosive properties in comparison with the range of from 0.5 to 1.4 g/m², but still being sufficient.

In absolute values, Bi₂O₃ and ZnO-layers showed the best anti-corrosive results, however, with relatively high layer-thicknesses compared to the TiO₂-layers.

TABLE 5

| | | | Electrode | Current strength/ | Current | | |
|---|---|---|---|---|---|---|---|
| Electrolyte | Temp. | Stirring | Surface | Amperage | Density | | t/min |
| 0.01 mol/L | R.T. | 300 RPM | 10 cm² | 200 mA | 20 | mA/cm² | 20 min. |
| ZnSO₄•7H₂O | | | | | | | |
| 0.1 mol/L Na₂SO₄ | | | | | | | |
| pH = 5.75 | | | | | | | |
| (Passing-in of air) | | | | | | | |
| 0.01 mol/L | R.T. | 300 RPM | 10 cm² | 100 mA | 10 | mA/cm² | 20 min. |
| ZnSO₄•7H₂O | | | | | | | |
| 0.1 mol/L Na₂SO₄ | | | | | | | |
| pH = 5.75 | | | | | | | |
| (Passing-in of air) | | | | | | | |
| 0.01 mol/L | R.T. | 300 RPM | 10 cm² | 50 mA | 5 | mA/cm² | 20 min. |
| ZnSO₄•7H₂O | | | | | | | |
| 0.1 mol/L Na₂SO₄ | | | | | | | |
| pH = 5.75 | | | | | | | |
| (Passing-in of air) | | | | | | | |
| 0.01 mol/L | R.T. | 300 RPM | 10 cm² | 10 mA | 1 | mA/cm² | 20 min. |
| ZnSO₄•7H₂O | | | | | | | |
| 0.1 mol/L Na₂SO₄ | | | | | | | |
| pH = 5.75 | | | | | | | |
| (Passing-in of air) | | | | | | | |
| 0.01 mol/L | R.T. | 300 RPM | 10 cm² | 10 mA | 1 | mA/cm² | 20 min. |
| ZnSO₄•7H₂O | | | | | | | |
| 0.1 mol/L Na₂SO₄ | | | | | | | |
| pH = 5.75 (air) - | | | | | | | |
| fresh electrolyte | | | | | | | |
| 0.01 mol/L | R.T. | 300 RPM | 10 cm² | 25 mA | 2.5 | mA/cm² | 20 min. |
| ZnSO₄•7H₂O | | | | | | | |
| 0.1 mol/L Na₂SO₄ | | | | | | | |
| pH = 5.75 | | | | | | | |
| (Passing-in of air) | | | | | | | |
| 0.01 mol/L | R.T. | 300 RPM | 10 cm² | 25 mA | 2.5 | mA/cm² | 20 min. |
| ZnSO₄•7H₂O | | | | | | | |
| 0.1 mol/L Na₂SO₄ | | | | | | | |
| pH = 5.75 | | | | | | | |
| (Passing-in of air) | | | | | | | |
| 0.01 mol/L | 60° C. | 300 RPM | 10 cm² | 25 mA | 2.5 | mA/cm² | 20 min. |
| ZnSO₄•7H₂O | | | | | | | |
| 0.1 mol/L Na₂SO₄ | | | | | | | |
| pH = 5.75 | | | | | | | |
| (Passing-in of air) | | | | | | | |
| 0.1 mol/L | R.T. | 300 RPM | 10 cm² | 25 mA | 2.5 | mA/cm² | 20 min. |
| ZnSO₄•7H₂O | | | | | | | |
| pH = 5.45 | | | | | | | |
| (Passing-in of air) | | | | | | | |
| 0.1 mol/L | R.T. | 300 RPM | 10 cm² | 25 mA | 2.5 | mA/cm² | 10 min. |
| ZnSO₄•7H₂O | | | | | | | |
| pH = 5.45 | | | | | | | |
| (Passing-in of air) | | | | | | | |
| 0.1 mol/L | R.T. | 300 RPM | 10 cm² | 25 mA | 2.5 | mA/cm² | 5 min. |
| ZnSO₄•7H₂O | | | | | | | |
| pH = 5.45 | | | | | | | |
| (Passing-in of air) | | | | | | | |
| 0.1 mol/L | R.T. | 300 RPM | 10 cm² | 25 mA | 2.5 | mA/cm² | 2 min. |
| ZnSO₄•7H₂O | | | | | | | |
| pH = 5.55 | | | | | | | |
| (Passing-in of air) | | | | | | | |

R.T. = Room Temperature

TABLE 6

| | | | | Current | | |
|---|---|---|---|---|---|---|
| | | | Electrode | Strength/ | Current | |
| Electrolyte | Temp. | Stirring | Surface | Amperage | Density | t/min |
| 0.1 M Bi(NO₃)₃ | R.T. | 300 RPM | 10 cm² | 50 mA, | 5 mA/cm² | 10 min. |
| 0.25 M L(+)-tartric acid | | | | cathodic | | |
| 2.5 M KOH | | | | | | |
| 0.1 M Bi(NO₃)₃ | R.T. | 300 RPM | 10 cm² | 50 mA, | 5 mA/cm² | 10 min. |
| 0.25 M L(+)-tartric acid | | | | anodic | | |
| 2.5 M KOH | | | | | | |
| 0.1 M Bi(NO₃)₃ | 65° C. | 300 RPM | 10 cm² | 50 mA, | 5 mA/cm² | 10 min. |
| 0.25 M L(+)-tartric acid | | | | anodic | | |
| 2.5 M KOH | | | | | | |
| 0.1 M BiO(NO₃) | R.T. | 300 RPM | 10 cm² | 10 mA, | 1 mA/cm² | 10 min. |
| (calc. as Bi-subnitrate) | | | | anodic | | |
| 0.25 M L(+)-tartric acid | | | | | | |
| 2.5 M KOH | | | | | | |
| 0.1 M BiO(NO₃) | R.T. | 300 RPM | 10 cm² | 10 mA, | 1 mA/cm² | 10 min. |
| (calc. as Bi-subnitrate) | | | | anodic | | |
| 0.25 M L(+)-tartric acid | | | | | | |
| 2.5 M KOH | | | | | | |
| 0.1 M BiO(NO₃) | R.T. | 300 RPM | 10 cm² | 30 mA, | 3 mA/cm² | 10 min. |
| (calc. as Bi-subnitrate) | | | | anodic | | |
| 0.25 ML(+)-tartric acid . | | | | | | |
| 2.5 M KOH | | | | | | |
| 0.1 M BiO(NO₃) | R.T. | 300 RPM | 10 cm² | 50 mA, | 5 mA/cm² | 10 min. |
| (calc. as Bi-subnitrate) | | | | anodic | | |
| 0.25 M L(+)-tartric acid. | | | | | | |
| 2.5 M KOH | | | | | | |
| 0.1 M BiO(NO₃) | R.T. | 300 RPM | 10 cm² | 75 mA, | 7.5 mA/cm² | 10 min. |
| (calc. as Bi-subnitrate) | | | | anodic | | |
| 0.25 M L(+)-tartric acid | | | | | | |
| 2.5 M KOH | | | | | | |
| 0.1 M BiO(NO₃) | R.T. | 300 RPM | 10 cm² | 50 mA, | 5 mA/cm² | 10 min. |
| (calc. as Bi-subnitrate) | | | | anodic | | |
| 0.25 M L(+)-tartric acid | | | | | | |
| 2.5 M KOH | | | | | | |

R.T. = Room Temperature

What is claimed is:

1. A process for providing a metal substrate with corrosion-protection and/or corrosion-resistance, said process comprising: coating said metal substrate with a thin layer of at least one metal oxide selected from the group consisting of TiO₂, Bi₂O₃ and ZnO, by electrochemically depositing said metal oxide layer on at least one surface of said metal substrate.

2. The process according to claim 1, wherein said metal oxide layer is obtained as an abrasion-resistant and dense, compact layer on at least one surface of said metal substrate and/or wherein said metal oxide layer is deposited with an essentially homogeneous and continuous thickness and/or wherein said metal oxide layer is deposited as an essentially continuous coating being essentially free of cracks.

3. The process according to claim 1, wherein said metal oxide layer obtained is a TiO₂-layer.

4. The process according to claim 2, wherein said TiO₂-layer has an essentially uniform layer thickness, said layer thickness being in the range of at least 0.01 g/m² and up to 3.5 g/m² calculated as weight per unit area.

5. The process according to claim 4, wherein said layer thickness is in the range of at least 0.1 g/m² and up to 3.0 g/m² calculated as weight per unit area.

6. The process according to claim 1, wherein said metal oxide layer obtained is:
a) a ZnO-layer having an essentially uniform layer thickness, calculated as weight per unit area, in the range of from 0.01 to 9.0 g/m²; or
b) a Bi₂O₃-layer having an essentially uniform layer thickness, calculated as weight per unit area, in the range of from 0.01 to 8.0 g/m².

7. The process according to claim 6, wherein said metal oxide layer obtained is a ZnO-layer having a layer thickness in the range of from 1.5 to 4 g/m².

8. The process according to claim 6, wherein said metal oxide layer obtained is a Bi₂O₃-layer having a layer thickness in the range of from 0.9 to 5.1 g/m².

9. The process according to claim 1, wherein electrochemical deposition is performed in an electrolytic bath, said electrolytic bath containing:
(i) at least one precursor salt of said metal oxide, said precursor salt being soluble in said electrolytic bath and being electrochemically depositable as a metal oxide;
(ii) at least one conducting salt; and
(iii) optionally one or more additives and/or aids selected from the group consisting of stabilizers; complexing or sequestering agents; accelerators or promoting agents; and buffering agents.

10. The process according to claim 1, wherein said electrochemical deposition is run galvanostatically and/or wherein said electrochemical deposition is performed at a temperature in the range of between 0 and 100° C., and/or with a cathodic current density of between 0.01 and 100 mA/cm², and/or for a duration of between 30 seconds and 20 minutes.

11. The process according to claim 1, wherein said electrochemical deposition is run galvanostatically and/or wherein said electrochemical deposition is performed at a temperature in the range of between 20 and 60° C., and/or with a cathodic current density of between 0.1 and 10 mA/cm², and/or for a duration of between 30 seconds and 10 minutes.

12. The process according to claim 1, wherein said electrochemical deposition is performed in an essentially peroxide-free electrolyte and/or wherein said electrochemical deposition is performed in an electrolyte being essentially free of halides.

13. A metal substrate provided with a corrosion-protection and/or corrosion-resistance, wherein said metal substrate is coated on at least one surface with an abrasion-resistant and dense, compact layer of at least one metal oxide selected from the group consisting of TiO₂, Bi₂O₃ and ZnO, said metal oxide layer being electrochemically deposited on said metal substrate.

14. The metal substrate according to claim 13, wherein said metal oxide layer is a TiO₂-layer deposited on said metal substrate with an essentially uniform thickness, calculated as weight per unit area, in the range of from 0.01 to 3.5 g/m²; and/or wherein said metal substrate is a conductive metal substrate.

15. The metal substrate according to claim 14, wherein said conductive metal substrate is selected from the group consisting of iron, aluminum, magnesium and their alloys and mixtures.

16. The metal substrate according to claim 15, wherein said conductive metal substrate is steel.

17. The metal substrate according to claim 13 wherein the thickness of the metal oxide layer is in the range of 0.5 to 1.4 g/m².
